(19) United States
(12) Patent Application Publication
(10) Pub. No.: US 2013/0091876 A1
(43) Pub. Date: Apr. 18, 2013

(54) TEMPERATURE CONTROL SYSTEM AND METHOD FOR A CHAMBER OR PLATFORM AND TEMPERATURE-CONTROLLED CHAMBER OR PLATFORM INCLUDING THE TEMPERATURE CONTROL SYSTEM

(71) Applicant: Chuan WENG, Cumming, GA (US)

(72) Inventor: Chuan WENG, Cumming, GA (US)

(73) Assignee: TEMPTRONIC CORPORATION, Mansfield, MA (US)

(21) Appl. No.: 13/275,976

(22) Filed: Oct. 18, 2011

(51) Int. Cl. F25D 3/10; F25D 17/02; F25B 49/00; G05D 23/19

(52) U.S. Cl. 62/64; 62/189; 165/287

(57) ABSTRACT

A temperature control system and method include a source of a temperature control medium that is to be introduced into a space. A fluid line conveys the temperature control medium from the source to the space, a first end of the fluid line being disposed in the space. An orifice assembly has an orifice through which the cooling medium flows toward the space. A size of the orifice is adjustable such that a rate of flow of the cooling medium entering the space is controllable.

### BACKGROUND

The present disclosure is directed to temperature control systems methods and temperature-controlled platforms and chambers, and, in particular, to a temperature control system and method and a temperature-controlled platform and/or chamber using the temperature control system and/or method, in which temperature is controlled accurately and precisely.

In temperature-controlled chambers or temperature-controlled thermal platforms or plates, a conventional refrigeration system typically uses a solenoid valve to inject a cool fluid such as liquid nitrogen (LN₂) directly into the chamber space or thermal platform or plate to achieve a refrigeration effect. In such conventional systems, temperature control is achieved by modulating the flow rate of the LN₂ by turning the LN₂ supply system on and off. This is typically accomplished by opening and closing the solenoid valve. This approach has several drawbacks. For example, frequent cycling of the valve can result in premature failure of the valve. Also, temperature can be overcompensated, resulting in undesirable overshoot, undershoot and/or oscillation of the temperature.

### SUMMARY

According to one aspect, the present disclosure is directed to a temperature control system. The temperature control system includes a source of a temperature control medium that is to be introduced into a space. A fluid line conveys the temperature control medium from the source to the space, a first end of the fluid line being disposed in the space. An orifice assembly has an orifice through which the cooling medium flows toward the space. A size of the orifice is adjustable such that a rate of flow of the cooling medium entering the space is controllable.

According to some exemplary embodiments, the temperature control system further comprises an actuating device coupled to the orifice assembly for adjusting the size of the orifice in the orifice assembly. The actuating device can include a motor. The motor can be coupled to a lead screw, the lead screw moving a plug within the orifice assembly to change the size of the orifice. A controller can be coupled to the actuating device for controlling the actuating device. A temperature sensor can sense a temperature in the space, generate a signal indicative of the temperature in the space, and forward the signal to the controller.

According to some exemplary embodiments, the temperature control medium comprises at least one of liquid nitrogen (LN₂) and liquid carbon dioxide (LCO₂).

According to some exemplary embodiments, the temperature control system further comprises a plurality of interchangeable orifice elements, the orifice elements having respective orifices of different respective sizes.

According to some exemplary embodiments, the temperature control system further comprises a valve in the fluid line between the source and the first end of the fluid line for controlling flow of the temperature control medium in the fluid line.

According to some exemplary embodiments, the space is in a temperature-controlled chamber. Alternatively, according to some exemplary embodiments, the space is in a temperature-controlled platform.

According to another aspect, the present disclosure is directed to a temperature control system, which includes a space and a source of a temperature control medium to be introduced into the space. A fluid line conveys the temperature control medium from the source to the space, a first end of the fluid line being disposed in the space. An orifice assembly has an orifice through which the cooling medium flows toward the space. A size of the orifice is adjustable such that a rate of flow of the cooling medium entering the space is controllable.

According to some exemplary embodiments, the temperature control system further comprises an actuating device coupled to the orifice assembly for adjusting the size of the orifice in the orifice assembly. The actuating device can include a motor. The motor can be coupled to a lead screw, the lead screw moving a plug within the orifice assembly to change the size of the orifice. A controller can be coupled to the actuating device for controlling the actuating device. A temperature sensor can sense a temperature in the space, generate a signal indicative of the temperature in the space, and forward the signal to the controller.

According to some exemplary embodiments, the temperature control medium comprises at least one of liquid nitrogen (LN₂) and liquid carbon dioxide (LCO₂).

According to some exemplary embodiments, the temperature control system further comprises a plurality of interchangeable orifice elements, the orifice elements having respective orifices of different respective sizes.

According to some exemplary embodiments, the temperature control system further comprises a valve in the fluid line between the source and the first end of the fluid line for controlling flow of the temperature control medium in the fluid line.

According to some exemplary embodiments, the space is in a temperature-controlled chamber. Alternatively, according to some exemplary embodiments, the space is in a temperature-controlled platform.

According to another aspect, the present disclosure is directed to a method of controlling temperature in a space. The method includes conveying a temperature control medium through a fluid line from a source of the temperature control medium to a first end of the fluid line. An orifice assembly has an orifice through which the cooling medium flows to enter the space. The method further includes adjusting a size of the orifice such that a rate of flow of the cooling medium entering the space is controllable.

According to some exemplary embodiments, the method further comprises sensing a temperature inside the space and adjusting the size of the orifice to control the temperature inside the chamber.

According to some exemplary embodiments, the space is in a temperature-controlled chamber. Alternatively, according to some exemplary embodiments, the space is in a temperature-controlled platform.

### BRIEF DESCRIPTION OF THE DRAWINGS

The foregoing and other features and advantages of the disclosure will be apparent from the more particular description of preferred embodiments, as illustrated in the accompanying drawings, in which like reference characters refer to the same parts throughout the different views. The drawings are not necessarily to scale, emphasis instead being placed upon illustrating the principles of the disclosure.

FIG. 1 contains a schematic block diagram of a system in which temperature is controlled, according to some exemplary embodiments.

FIG. 2 contains a schematic block diagram of another system in which temperature is controlled, according to some exemplary embodiments.

FIG. 3 is a schematic cross-sectional diagram of the orifice assembly illustrated in FIGS. 1 and 2, according to some exemplary embodiments.

FIG. 4 is a schematic cross-sectional diagram of the orifice assembly illustrated in FIGS. 1 and 2, according to some exemplary embodiments, with a different orifice fitting than that of FIG. 3.

FIG. 5 contains a schematic block diagram of another system in which temperature is controlled, according to some exemplary embodiments.

FIG. 6 contains a schematic block diagram of another system in which temperature is controlled, according to some exemplary embodiments.

FIG. 7 is a schematic cross-sectional diagram of the orifice assembly illustrated in FIGS. 5 and 6, according to some exemplary embodiments.

### DETAILED DESCRIPTION

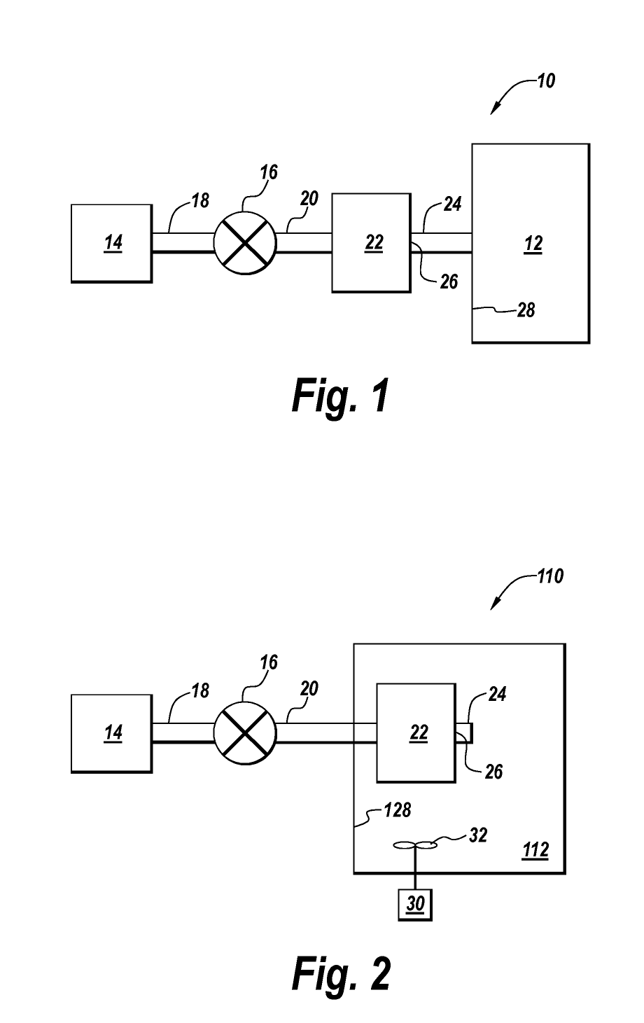

FIG. 1 contains a schematic block diagram of a system in which temperature is controlled, according to some exemplary embodiments. Referring to FIG. 1, the system 10 includes a temperature-controlled chamber or a temperature-controlled platform or plate 12. The temperature-controlled chamber 12 and temperature-controlled platform or plate 12 can be used, for example, in temperature testing a device under test (DUT), such as an integrated circuit chip die or wafer. In the case of the chamber, the DUT is placed within the chamber, and the environment within the chamber, e.g., temperature, humidity, pressure, etc., can be controlled. In the case of a chamber, one or more fans may be used within the chamber to circulate the ambient, e.g., air, or nitrogen gas, within the chamber to achieve uniform environmental, e.g., temperature, control. In the case of the temperature-controlled platform or plate, a DUT can be placed on the platform or plate, and the temperature of the DUT can be controlled by controlling the temperature of the platform or plate. This can be accomplished by, for example, circulating a temperature control fluid, e.g., chilled air, through an array of channels in the platform or plate. This can be done in connection with a resistive heating layer disposed within the platform or plate. It should be noted that the temperature-controlled “space” referred to herein is a space within the chamber or a space within the circulating channels of the platform or plate, depending upon the context.

Examples of temperature-controlled chambers to which the present disclosure is applicable include any of the environmental chambers manufactured and sold by in TEST Corporation of Mt. Laurel, N.J., USA. Examples of temperature-controlled platforms or plates to which the present disclosure is applicable include any of the thermal platforms or plates manufactured and sold by in TEST Corporation of Mt. Laurel, N.J., USA

The system 10 of FIG. 1 also includes a source 14 of a cooling medium. In some particular exemplary embodiments, the cooling medium can include, for example, liquid nitrogen (LN₂). In some particular exemplary embodiments, the cooling medium can include, for example, liquid carbon dioxide (LCO₂). It will be noted that in the present Detailed Description, the cooling medium is described as including LN2. It will be understood that, according to the disclosure, the cooling medium may also include LCO₂. The cooling medium, e.g., LN₂ and/or LCO₂, is routed to the chamber or plate or platform 12. A fluid line 18 carries the cooling medium to a solenoid valve 16. The solenoid valve 16 is controlled to be either open to allow the cooling medium to flow toward the chamber or platform 12 or closed to prevent the cooling medium from flowing toward the chamber or platform 12. When the solenoid valve 16 is open, the cooling medium flows out of the solenoid valve 16 and into another fluid line 20, which conveys the cooling medium to an orifice assembly 22. The orifice assembly 22 includes an opening or orifice 26 through which the cooling medium flows to exit the orifice assembly 22 and continue flowing toward the chamber or platform 12. The cooling medium flows from the orifice assembly 22 into the chamber or platform 12 via another fluid line 24 connected between the orifice assembly 22 and the chamber or platform 12.

The cooling medium flows from the orifice assembly 22 into the chamber or platform 12 at a flow rate which is controlled by the size of the opening or orifice 26 at the output of the orifice assembly 22. According to the inventive concept, the size of the opening or orifice 26 is adjustable such that the flow rate of the cooling medium is controllable such that the desired refrigeration effect at the chamber or platform 12 is obtained. That is, by varying and controlling the size of the orifice 26, the flow rate is tailored to the demand of the particular load, as the orifice 26 expands the fluid into the space of the chamber or platform or plate for cooling. Also, the flow factor of the valve 16 is chosen to be large enough so that the final flow delivered by the orifice 26 is less than the flow rate capability of the valve 16. The proper amount of flow is achieved according to the present disclosure by using variable and controllable orifice sizes in the fluid path. This approach of the present disclosure of varying and controlling the size of the orifice 26 to control the rate of flow of the cooing medium to achieve the desired refrigeration effect is in contrast to conventional systems as noted above, which attempt to obtain a refrigeration effect by modulating the flow rate of a cooling medium by turning flow on and off by cycling the solenoid valve between the open and closed states.

According to the present disclosure, as the incoming LN₂ pressures vary, a suitable amount of flow can be maintained with the same valve injector assembly by adapting orifice size with flow characteristics appropriate for the incoming LN₂ pressure. Therefore, the controllability of the system is also maintained to avoid over compensating in the cooling mode. Increasing the size of the orifice 26 can also compensate for the loss of performance due to a lowered supply line pressure. Furthermore, the length of the fluid line 20 between the solenoid valve 16 and the orifice assembly 22 is eliminated as a factor impacting the flow rate, since the expansion of the pressurized liquid, e.g., LN₂, occurs only in the orifice 26. This allows for the flexibility to mount the solenoid valve in a location that suits the need for better manufacturability and service, while the liquid can be delivered to an appropriate point for expansion.

FIG. 2 contains a schematic block diagram of another system in which temperature is controlled, according to some exemplary embodiments. The difference between the systems of FIGS. 1 and 2 is that, in the system 10 of FIG. 1, the orifice assembly 22 is located external to the chamber or platform 12, while in the system 110 of FIG. 2, the orifice assembly 22 is located within the chamber 112. Otherwise, the systems of FIGS. 1 and 2 are structurally and functionally the same. Elements of the embodiment of FIG. 2 that are the same as corresponding elements of the embodiment of FIG. 1 are identified by like reference numerals. Detailed description of those like elements will not be repeated. It is noted that the embodiment of FIG. 2 is applicable to a chamber 112, but not to a temperature-controlled platform or plate.

Referring to FIG. 2, the fluid line 20 carrying the cooling medium from the solenoid valve 16 to the orifice assembly 22 penetrates the wall 128 of the chamber 112. The drawing of FIG. 2 also schematically illustrates a fan motor 30 used to drive a fan 32 within the chamber 112 to circulate the internal environmental conditions of the chamber 112.

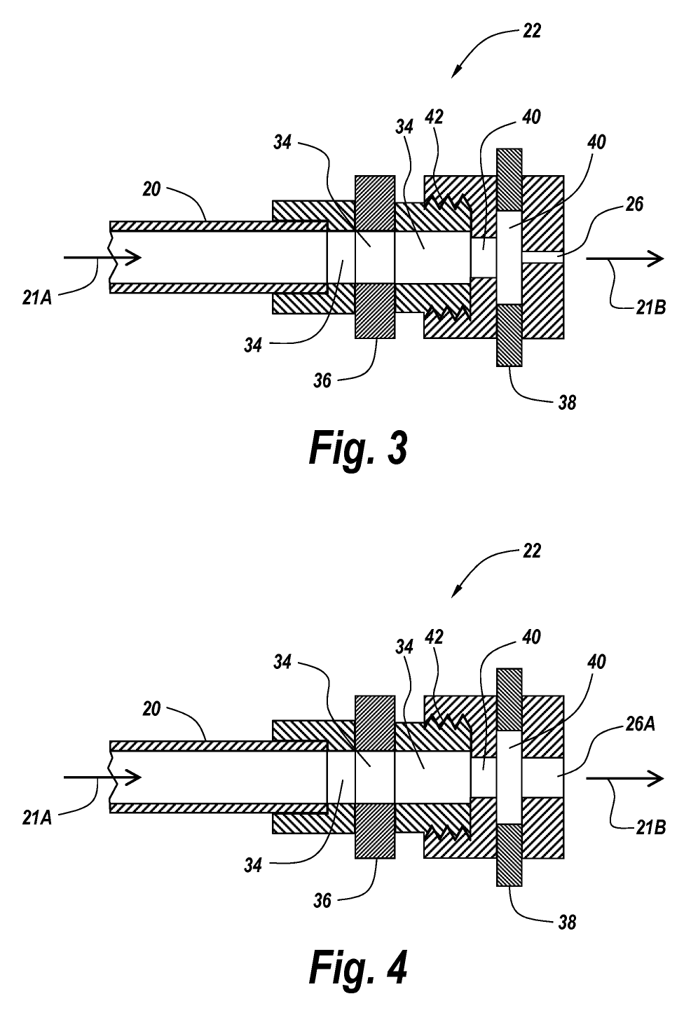

FIG. 3 is a schematic cross-sectional diagram of the orifice assembly 22 illustrated in FIGS. 1 and 2, according to some exemplary embodiments. Referring to FIG. 3, the fluid line 20 is fixedly connected at an input end of the orifice assembly 22. The cooling medium flows from the fluid line 20, into the input end of the orifice assembly 22, through the orifice assembly 22 and out of the orifice assembly 22 through the opening or orifice 26 at the output end of the orifice assembly 22, as indicated by flow direction arrows 21A and 21B.

In some exemplary embodiments, the orifice assembly 22 includes a transition fitting 36 fixedly attached to the fluid line 20. The transition fitting 36 includes one or more interior channels 34 through which the cooling medium flows. The orifice assembly 22 also includes an orifice fitting 38, which is attached to the transition fitting 36 in a removable configuration, such as by threads 42. The removable orifice fitting 38 also includes one or more interior channels 40 through which the cooling medium flows. The removable orifice fitting 38 also includes the opening or orifice 26 through which the cooling medium flows toward the chamber or platform 12, 112. The size of the orifice 26 controls the flow rate of the cooling medium and, therefore, the refrigeration effect achieved by the system 10, 110.

According to the present disclosure, the orifice fitting 38 can be readily removed from the transition fitting 36 and replaced with a different orifice fitting 38 having an orifice 26 of a different size, such that a different flow rate is obtained. According to the present disclosure, the system 10, 100 includes a plurality of orifice fittings 38 having a respective plurality of openings or orifices 26 of a respective plurality of sizes, providing a respective plurality of flow rates.

FIG. 4 is a schematic cross-sectional diagram of the orifice assembly 22 illustrated in FIGS. 1 and 2, according to some exemplary embodiments, with a different orifice fitting 238 than that of FIG. 3. Referring to FIG. 4, the orifice fitting 238 has replaced the orifice fitting 38 of FIG. 3 on the transition fitting 36. The orifice fitting 238 of FIG. 4 has a different opening or orifice 26A than that of the orifice fitting 38 of FIG. 3. Specifically, in the illustrated exemplary embodiment, the orifice 26A of the orifice fitting 238 of FIG. 4 is larger than that of FIG. 3, resulting in a higher flow rate of the cooling medium.

Hence, according to the present disclosure, when higher cooling medium flow rate is desired, an orifice fitting with a larger orifice can be used. When a lower cooling medium flow rate is desired, the orifice fitting can be changed to provide a smaller orifice. Flow rates can be changed for various reasons. For example, flow rate may be increased by changing to a larger orifice when more cooling is desired, such as when the set temperature of the chamber or platform is in transition to a lower temperature. In contrast, when less cooling is required, such as when the set temperature of the chamber or platform is in transition to a higher temperature, it may be desirable to change to a smaller orifice. Also, pressure variations in the source may be compensated by changing orifice fittings. For example, if the source pressure increases, the orifice fitting may be changed to provide a lower flow, and, if the source pressure decreases, the orifice fitting may be changed to provide a higher flow.

According to the present disclosure, under certain temperature transition conditions in which flow of the cooling medium is adjusted by adjusting the size of the orifice, the flow of cooling medium is not interrupted, as it is in conventional systems. That is, the solenoid valve used to control the on and off state of the flow is not opened and closed to modulate the flow of cooling medium between the on an off states. That is, the interchangeable orifice provides the convenience of matching the flow rate requirement with a temperature demand and pressure variations in the supply line both during pull-down and cycling conditions in the chamber or plate or platform. In some particular exemplary embodiments, the on/off control of the valve is still in place with the orifice for expansion. When the chamber or plate or platform reaches the set point temperature, the valve can cycle on and off to maintain the set temperature.

In the embodiments described above, the size of the opening or orifice is adjusted by changing the orifice fitting to one having an orifice of a desired size. According to the present disclosure, the size of the opening or orifice can also be adjusted automatically, without the need to change an orifice fitting.

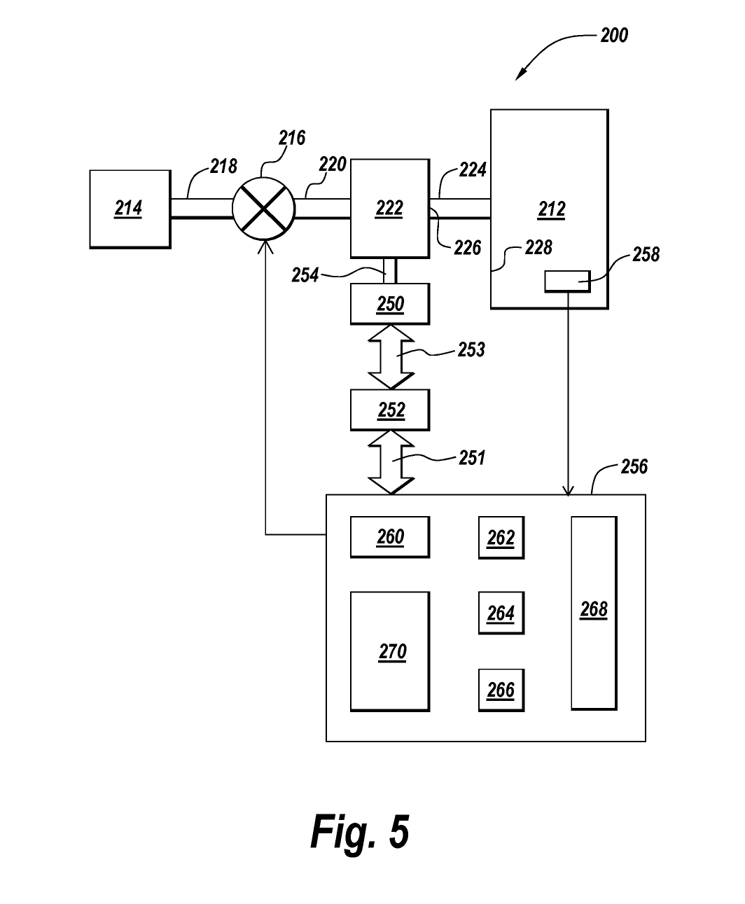

FIG. 5 contains a schematic block diagram of another system in which temperature is controlled, according to some exemplary embodiments. In the embodiment of FIG. 5, the size of the opening or orifice is controlled automatically, based in part on feedback related to actual sensed temperature in the chamber or platform or plate.

Referring to FIG. 5, the system 200 includes a temperature-controlled chamber or a temperature-controlled platform or plate 212. As described above in detail in connection with the embodiments illustrated in FIGS. 1 through 4, the temperature-controlled chamber and temperature-controlled platform or plate 212 can be used, for example, in temperature testing a device under test (DUT), such as an integrated circuit chip die or wafer. In the case of the chamber, the DUT is placed within the chamber, and the environment, e.g., temperature, humidity, pressure, etc., can be controlled. In the case of a chamber, one or more fans may be used within the chamber to circulate the ambient, e.g., air, within the chamber to achieve uniform environmental, e.g., temperature, control. In the case of the temperature-controlled platform or plate, a DUT can be placed on the platform or plate, and the temperature of the DUT can be controlled by controlling the temperature of the platform or plate. This can be accomplished by, for example, circulating a temperature control fluid, e.g., chilled air, through an array of channels in the platform or plate. This can be done in connection with a resistive heating layer disposed within the platform or plate.

The system 200 of FIG. 5 also includes a source 214 of the cooling medium. As described above, in some particular exemplary embodiments, the cooling medium can include, for example, liquid nitrogen (LN₂). In some particular exemplary embodiments, the cooling medium can include, for example, liquid carbon dioxide (LCO₂). It will be noted that in this Detailed Description, the cooling medium is described as including LN2. It will be understood that, according to the disclosure, the cooling medium may also include LCO₂. The cooling medium, e.g., LN₂ and/or LCO₂, is routed to the chamber or plate or platform 212. A fluid line 218 carries the cooling medium to a solenoid valve 216. The solenoid valve 216 is controlled by a controller 256 via a control line to be either open to allow the cooling medium to flow toward the chamber or platform 212 or closed to prevent the cooling medium from flowing toward the chamber or platform 212. When the solenoid valve 216 is open, the cooling medium flows out of the solenoid valve 216 and into another fluid line 220, which transports the cooling medium to an orifice assembly 222. The orifice assembly 222 includes an opening or orifice 226 through which the cooling medium flows to exit the orifice assembly 222 and continue flowing toward the chamber or platform 212. In some exemplary embodiments, the cooling medium flows from the orifice assembly 222 into the chamber or platform 212 via another fluid line 224 connected between the orifice assembly 222 and the chamber or platform 212.

The cooling medium flows from the orifice assembly 222 into the chamber or platform 212 at a flow rate which is controlled by the size of the opening or orifice 226 at the output of the orifice assembly 222. According to the inventive concept, the size of the opening or orifice 226 is adjustable such that the flow rate of the cooling medium is controllable such that the desired refrigeration effect at the chamber or platform 212 is obtained. That is, by varying and controlling the size of the orifice 226, the flow rate is tailored to the demand of the particular load, as the orifice expands the fluid into the space of the chamber or platform or plate for cooling. Also, the flow factor of the valve 216 is chosen to be large enough so that the final flow delivered by the orifice 222 is less than the flow rate capability of the valve 216. The proper amount of flow is achieved according to the present disclosure by using variable and controllable orifice sizes in the fluid path. This approach of the present disclosure of varying and controlling the size of the orifice 226 to control the rate of flow of the cooing medium to achieve the desired refrigeration effect during temperature transition is in contrast to conventional systems as noted above, which attempt to obtain a refrigeration effect during temperature transition by modulating the flow rate of a cooling medium by turning flow on and off by cycling the solenoid valve between the open and closed states.

According to the present disclosure, as the incoming LN₂ pressures vary, a suitable amount of flow can be maintained with the same valve injector assembly by adapting orifice size with flow characteristics appropriate for the incoming LN₂ pressure. Therefore, the controllability of the system is also maintained to avoid over compensating in the cooling mode. Increasing the size of the orifice 226 can also compensate for the loss of performance due to a lowered supply line pressure. Furthermore, the length of the fluid line 220 between the solenoid valve 216 and the orifice assembly 222 is eliminated as a factor impacting the flow rate, since the expansion of the pressurized liquid, e.g., LN₂, occurs only in the orifice 226. The allows the flexibility to mount the solenoid valve 216 in a location that suits the need for better manufacturability and service, while the liquid can be delivered to an appropriate point for expansion.

As noted above, in the exemplary embodiment of FIG. 5, the orifice size is controlled automatically via the controller 256. The controller 256 receives a signal indicative of temperature at the chamber or platform 212 via the temperature sensor 258, which is mounted in or near and in thermal communication with the temperature-controlled space of the chamber or platform or plate 212. The controller 256 uses the sensed temperature to adjust the size of the orifice as desired.

The controller 256 includes a processor 260, which can be a microprocessor, microcontroller or other such device, which operates in connection with other circuitry, such as one or more memory circuits 262, 264, 266, which can be one or more of read-only memory (ROM), programmable ROM (PROM), random-access memory (RAM), electrically erasable PROM (EEPROM), or other type of memory. The controller 256 may also include some type of appropriate input/output (I/O) interface circuitry 268, as well as other peripheral circuitry required for operation of the controller 256. All of the circuitry in the controller 256 may be connected as appropriate, such as by wires, printed conductors, etc., which form one or more interconnections, buses, etc., (not shown) as required.

In some exemplary embodiments, the controller 256 controls the size of the orifice or opening 226 in the orifice assembly 222 via a motor such as a stepper motor. To that end, the controller 256 can be connected to a stepper motor drive circuit 252, which is connected to and commands and drives a stepper motor 250. The controller 256 transmits signals such as commands and data to the stepper motor drive circuit 252 via electrical interconnections 251. The stepper motor drive circuit 252 transmits signals such as commands, data and power signals to the stepper motor 250, via electrical interconnections 253, to drive the stepper motor 250 as required to adjust the size of the orifice or opening 226.

In some exemplary embodiments, the stepper motor drive circuit 252 is mechanically coupled to the orifice assembly 222 by a lead screw 254. Alternatively, in some exemplary embodiments, the lead screw 254 is a shaft or a combination of a lead screw and a shaft. As described below in detail, rotation of the lead screw and/or shaft 254 changes the size of the orifice or opening 226 in the orifice assembly 226. Hence, the controller 256 controls the flow rate of the cooling medium by commanding the stepper motor 250, via the stepper motor drive circuit 252, to rotate the lead screw and/or shaft 254.

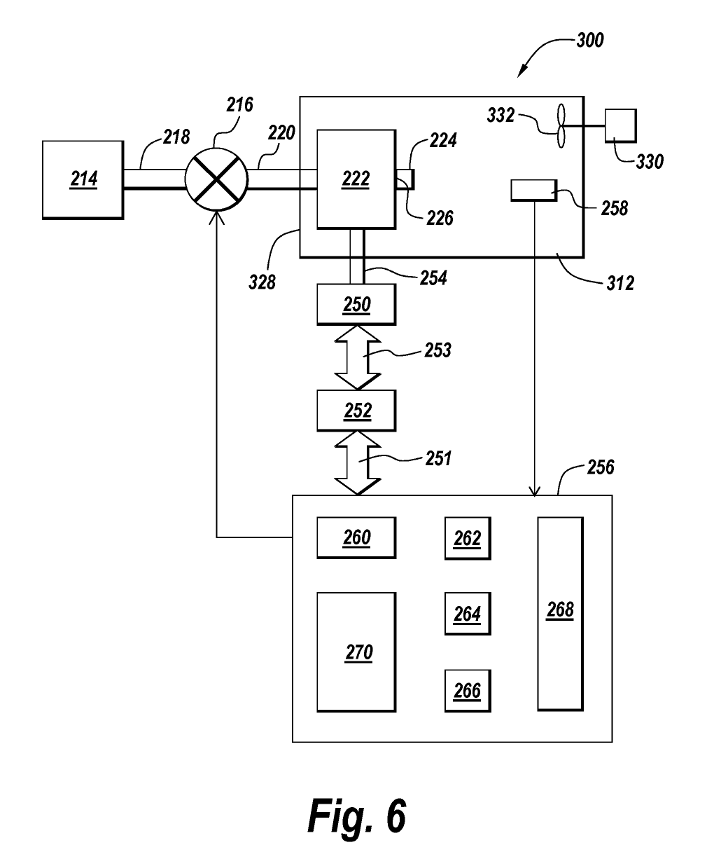

FIG. 6 contains a schematic block diagram of another system in which temperature is controlled, according to some exemplary embodiments. The difference between the systems of FIGS. 5 and 6 is that, in the system 200 of FIG. 5, the orifice assembly 222 is located external to the chamber or platform 212, while in the system 300 of FIG. 6 the orifice assembly 222 is located within the chamber 312. Otherwise, the systems of FIGS. 5 and 6 are structurally and functionally the same. Elements of the embodiment of FIG. 6 that are the same as corresponding elements of the embodiment of FIG. 5 are identified by like reference numerals. Detailed description of those like elements will not be repeated. It is noted that the embodiment of FIG. 6 is applicable to a chamber 312, but not to a temperature-controlled platform or plate.

Referring to FIG. 6, the fluid line 220 carrying the cooling medium from the solenoid valve 216 to the orifice assembly 222 penetrates the wall 328 of the chamber 312. Likewise, the lead screw and/or shaft 254 mechanically coupled between the stepper motor 250 and the orifice assembly 222 also penetrates the wall 328 of the chamber 312. The drawing of FIG. 6 also schematically illustrates a fan motor 330 used to drive a fan 332 within the chamber 312 to circulate the internal environmental conditions of the chamber 312.

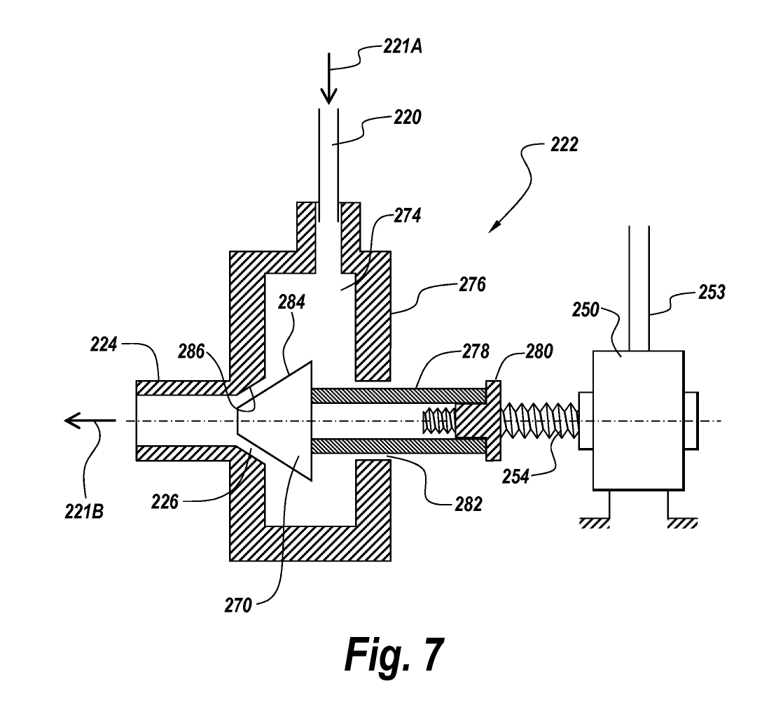

FIG. 7 is a schematic cross-sectional diagram of the orifice assembly 222 illustrated in FIGS. 5 and 6, according to some exemplary embodiments. Referring to FIG. 7, the input fluid line 220 is fixedly connected at an input end of a body portion 276 of the orifice assembly 222. The cooling medium flows from the input fluid line 220, into the input end of the of the orifice assembly 222, through a valve chamber portion 274 of the orifice assembly 222 and out of the orifice assembly 222 through the opening or orifice 226 at the output end of the orifice assembly 222, as indicated by flow direction arrows 221A and 221B. Fluid line 224 is connected to or is formed integrally with the output side of the orifice assembly 222.

Continuing to refer to FIG. 7, the orifice assembly 222 also includes an orifice plug 270 fixedly connected at its back end to an end of an orifice plug shaft 278, which is free to slide within an opening 282 in the body 276 of the orifice assembly 222. The front end 284 of the orifice plug is tapered to mate with a tapered section 286 of the opening in the body 276 of the assembly 222. When the tapered plug 270 is advanced forward such that it mates in contact with the tapered opening 286, the orifice 226 is closed, and flow of the cooling medium is stopped. When the tapered plug is withdrawn from the tapered opening 286, the cooling medium flows out of the orifice 226. The rate of flow of the cooling medium is determined by the size of the orifice or opening 226 between the tapered plug 270 and the tapered surfaces 286 of the opening in the body 276 of the assembly 222. As the plug 270 is withdrawn, the size of the orifice 226 and the rate of flow increase. As the plug is inserted forward into the opening 286, the size of the orifice 226 and the flow rate decrease.

The tapered plug 270 is moved in and out of the opening 286 to adjust the size of the orifice 226 by the plug shaft 278. To that end, the lead screw 254 is attached to a cap 280 at an internally threaded axial hole in the cap 280 by threaded mating of external threads on the lead screw 254. The cap 280 is fixedly attached to the end of the plug shaft 278. Since the stepper motor 250 and the body 276 of the assembly 222 are stationary with respect to each other, and the plug 270 and plug shaft 278 are movable together with respect to the motor and the body 276 of the assembly, when the lead screw is turned by the motor 250, the threaded mating between the lead screw 254 and the cap 280 causes the plug shaft 278 and the plug 270 to move axially toward and/or away from the tapered opening 286. As the lead screw is turned in a first direction, the plug 270 is advanced into the tapered opening 286 to reduce the size of the orifice 226 and the flow rate. As the lead screw is rotated in the opposite direction, the plug 270 is withdrawn from the opening 286 to increase the size of the orifice 226 and the flow rate. Thus, the controller 256 commands the motor 250 to turn the lead screw 254 either clockwise or counterclockwise (looking toward the back end of the tapered plug 270), depending upon whether it is desirable to increase or decrease the flow rate, respectively (assuming that the threads mating the lead screw 254 and cap 280 are right-handed).

According to the exemplary embodiments, the real-time feedback of the detected temperature allows the controller 256 to vary the size of the orifice 226 to suit a particular need of the chamber or platform 212, 312. For example, during a pull-down mode in which the temperature is brought down from a high temperature, the controller 256 may open the orifice more to allow additional coolant to enter the chamber or platform. When the temperature approaches the desired set temperature, the orifice size may reduced so that the chamber or platform temperature can be controlled more precisely. The same benefits can be achieved when the supply pressure varies. The variable and controllable orifice size can automatically adjust the flow rate to fit the need of a particular cooling demand, even when the supply pressure varies.

### Combinations of Features

Various features of the present disclosure have been described above in detail. The disclosure covers any and all combinations of any number of the features described herein, unless the description specifically excludes a combination of features. The following examples illustrate some of the combinations of features contemplated and disclosed herein in accordance with this disclosure.

In any of the embodiments described in detail and/or claimed herein, the temperature control system can further comprise an actuating device coupled to the orifice assembly for adjusting the size of the orifice in the orifice assembly.

In any of the embodiments described in detail and/or claimed herein, the actuating device can comprise a motor.

In any of the embodiments described in detail and/or claimed herein, the motor can be coupled to a lead screw, the lead screw moving a plug within the orifice assembly to change the size of the orifice.

In any of the embodiments described in detail and/or claimed herein, the temperature control system can further comprise a controller coupled to the actuating device for controlling the actuating device.

In any of the embodiments described in detail and/or claimed herein, the temperature control system can further comprise a temperature sensor for sensing a temperature in the space, generating a signal indicative of the temperature in the space, and forwarding the signal to the controller.

In any of the embodiments described in detail and/or claimed herein, the temperature control medium can comprise liquid nitrogen (LN₂).

In any of the embodiments described in detail and/or claimed herein, the temperature control system can further comprise a plurality of interchangeable orifice elements, the orifice elements having respective orifices of different respective sizes.

In any of the embodiments described in detail and/or claimed herein, the temperature control system can further comprise a valve in the fluid line between the source and the first end of the fluid line for controlling flow of the temperature control medium in the fluid line.

In any of the embodiments described in detail and/or claimed herein, the space can be in a temperature-controlled chamber.

In any of the embodiments described in detail and/or claimed herein, the space can be in a temperature-controlled platform.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims.

1. A temperature control system, comprising:
a source of a temperature control medium, the temperature control medium to be introduced into a space;
a fluid line for conveying the temperature control medium from the source to the space, a first end of the fluid line being disposed in the space; and
an orifice assembly having an orifice through which the cooling medium flows toward the space, a size of the orifice being adjustable such that a rate of flow of the cooling medium entering the space is controllable.

2. The temperature control system of claim 1, further comprising an actuating device coupled to the orifice assembly for adjusting the size of the orifice in the orifice assembly.

3. The temperature control system of claim 2, wherein the actuating device comprises a motor.

4. The temperature control system of claim 3, wherein the motor is coupled to a lead screw, the lead screw moving a plug within the orifice assembly to change the size of the orifice.

5. The temperature control system of claim 2, further comprising a controller coupled to the actuating device for controlling the actuating device.

6. The temperature control system of claim 5, further comprising a temperature sensor for sensing a temperature in the space, generating a signal indicative of the temperature in the space, and forwarding the signal to the controller.

7. The temperature control system of claim 1, wherein the temperature control medium comprises at least one of liquid nitrogen (LN₂) and liquid carbon dioxide (LCO₂).

8. The temperature control system of claim 1, further comprising a plurality of interchangeable orifice elements, the orifice elements having respective orifices of different respective sizes.

9. The temperature control system of claim 1, further comprising a valve in the fluid line between the source and the first end of the fluid line for controlling flow of the temperature control medium in the fluid line.

10. The temperature control system of claim 1, wherein the space is in a temperature-controlled chamber.

11. The temperature control system of claim 1, wherein the space is in a temperature-controlled platform.

12. A temperature control system, comprising:
a space;
a source of a temperature control medium, the temperature control medium to be introduced into the space;
a fluid line for conveying the temperature control medium from the source to the space, a first end of the fluid line being disposed in the space; and
an orifice assembly having an orifice through which the cooling medium flows toward the space, a size of the orifice being adjustable such that a rate of flow of the cooling medium entering the space is controllable.

13. The temperature control system of claim 12, further comprising an actuating device coupled to the orifice assembly for adjusting the size of the orifice in the orifice assembly.

14. The temperature control system of claim 13, wherein the actuating device comprises a motor.

15. The temperature control system of claim 14, wherein the motor is coupled to a lead screw, the lead screw moving a plug within the orifice assembly to change the size of the orifice.

16. The temperature control system of claim 13, further comprising a controller coupled to the actuating device for controlling the actuating device.

17. The temperature control system of claim 16, further comprising a temperature sensor for sensing a temperature in the space, generating a signal indicative of the temperature in the space, and forwarding the signal to the controller.

18. The temperature control system of claim 12, wherein the temperature control medium comprises at least one of liquid nitrogen (LN₂) and liquid carbon dioxide (LCO₂).

19. The temperature control system of claim 12, further comprising a plurality of interchangeable orifice elements, the orifice elements having respective orifices of different respective sizes.

20. The temperature control system of claim 12, further comprising a valve in the fluid line between the source and the first end of the fluid line for controlling flow of the temperature control medium in the fluid line.

21. The temperature control system of claim 12, wherein the space is in a temperature-controlled chamber.

22. The temperature control system of claim 12, wherein the space is in a temperature-controlled platform.

23. A method of controlling temperature in a space, comprising:
conveying a temperature control medium through a fluid line from a source of the temperature control medium to a first end of the fluid line, an orifice assembly having an orifice through which the cooling medium flows to enter the space; and
adjusting a size of the orifice such that a rate of flow of the cooling medium entering the space is controllable.

24. The method of claim 23, further comprising:
sensing a temperature inside the space; and
adjusting the size of the orifice to control the temperature inside the chamber.

25. The method of claim 23, wherein the space is in a temperature-controlled chamber.

26. The method of claim 23, wherein the space is in a temperature-controlled platform.
